(19) United States
(12) Patent Application Publication
(10) Pub. No.: US 2022/0197115 A1
(43) Pub. Date: Jun. 23, 2022

(54) SYSTEM FOR ACQUIRING THE IMAGE OF A LEAD AIRCRAFT FROM A FOLLOWER AIRCRAFT IN REDUCED BRIGHTNESS CONDITIONS

(71) Applicant: Airbus Operations SAS, Toulouse (FR)

(72) Inventors: Jean-Luc VIALATTE, Toulouse (FR); Maxime LEFORT, Toulouse (FR); Florent MONTET, Toulouse (FR)

(21) Appl. No.: 17/551,948

(22) Filed: Dec. 15, 2021

(30) Foreign Application Priority Data
Dec. 17, 2020 (FR) 2013428

(51) Int. Cl. G03B 15/00; H04N 5/225; G02B 5/122; G03B 15/02; B64D 47/06; B64D 47/08

(52) U.S. Cl. CPC G03B 15/006; H04N 5/2256; B64D 47/08; G03B 15/02; B64D 47/06; G02B 5/122

(57) ABSTRACT

A system for the acquisition of an image of a lead aircraft by a follower aircraft flying behind the lead aircraft. Such acquisition is made difficult when the ambient brightness drops, and even impossible at night. The system allows such night acquisition and comprises at least one camera installed on or in the follower aircraft, a lighting device provided on the follower aircraft and oriented at least partially towards the lead aircraft and a retroreflective device of retroreflector type disposed on the lead aircraft. When lit, the retroreflective device allows the camera to acquire an image of the zones marked by the retroreflective device despite the reduced brightness.

### CROSS-REFERENCES TO RELATED APPLICATIONS

This application claims the benefit of the French patent application No. 2013428 filed on Dec. 17, 2020, the entire disclosures of which are incorporated herein by way of reference.

### FIELD OF THE INVENTION

The present invention relates to a system for acquiring the image of a lead aircraft from a follower aircraft in a formation flight in which the follower aircraft flies in the wake of the lead aircraft in reduced brightness conditions, and notably at night.

### BACKGROUND OF THE INVENTION

In the aeronautical field, “formation flight” is understood to mean the flight of a formation of at least two aircraft, the one followed called lead, and the other called follower flying behind the lead aircraft. Such flights, in particular for commercial airplanes, have the advantage of reducing the fuel consumption of the follower aircraft by reducing its drag. However, the zone in which the follower aircraft must be located with respect to the lead aircraft is restricted and it is therefore necessary for the positioning of the follower aircraft to be accurate and fast.

The patent application FR2005541 filed on 26 May 2020 by AIRBUS OPERATIONS SAS and AIRBUS SAS discloses such a method in a daytime flying context. It requires the acquisition of the image of the lead aircraft by one or more video cameras which is difficult, even impossible, at night.

The aim of the present invention is to propose a system that makes it possible to acquire an image that is sufficient for the use of a positioning method like that described in the abovementioned patent application in reduced brightness conditions, even at night.

To this end, the present invention relates to aircraft in formation flight comprising a lead aircraft and a follower aircraft flying behind the lead aircraft, provided with a system for the acquisition of an image of the lead aircraft by the follower aircraft, characterized in that it comprises at least one camera installed on or in the follower aircraft, a lighting device provided on the follower aircraft and oriented at least partially towards the lead aircraft and a retroreflective device of retroreflector type disposed on the lead aircraft.

In this way, when lit, the retroreflective device allows the camera to acquire an image of the zones marked by said device despite the reduced brightness. The light reflected by the retroreflective device from the lead aircraft to the follower aircraft is sufficient to allow the marked zones to be delimited.

The invention provides at least one of the following optional features, taken alone or in combination.

The retroreflective device comprises at least one or more retroreflectors in an oblong form.

The retroreflective device takes the form of strips disposed on the outer surface of the lead aircraft.

Strips are affixed onto ridges of the fuselage of the lead airplane.

At least one of the strips is positioned on a part or all of the trailing edge of the air foil.

At least one of the strips is positioned on a part or all of the trailing edge of the horizontal tail unit.

At least one of the strips is positioned on a part or all of the trailing edge of the vertical tail unit.

At least one of the strips is positioned on a control surface.

The retroreflective device comprises a retroreflector at the end of the tail unit of the lead aircraft.

The lighting device comprises the landing lights of the follower aircraft.

### BRIEF DESCRIPTION OF THE DRAWINGS

Other aims, features and advantages will emerge from the following description of the invention, a description given purely as a nonlimiting example, with reference to the attached drawings in which:

FIG. 1 is a simplified perspective view of an example of a formation flight comprising a lead airplane and a follower airplane, both provided with the acquisition system according to the present invention;

FIG. 2 is a top schematic view of a formation flight such as that of FIG. 1 comprising two airplanes each provided with a reference frame and highlighting positioning data of the lead airplane with respect to the follower airplane;

FIG. 3 is a perspective view of an airplane provided with a reference frame and highlighting positioning data;

FIG. 4 is a partial perspective view of the interior of a follower airplane, in particular of an installation of a camera on the dashboard of the cockpit of said follower airplane;

FIG. 5 is a partial perspective view of an airplane whose landing lights are on;

FIG. 6 is a perspective view of a lead airplane in night flight, seen from a follower airplane, both provided with the acquisition system according to the present invention.

### DETAILED DESCRIPTION OF THE PREFERRED EMBODIMENTS

The present invention is illustrated hereinbelow with the example of a commercial airplane. However, it is not limited to this application and can relate to any type of aircraft in formation flight such as, for example, a fighter airplane, a sailwing or even a blended wing aircraft.

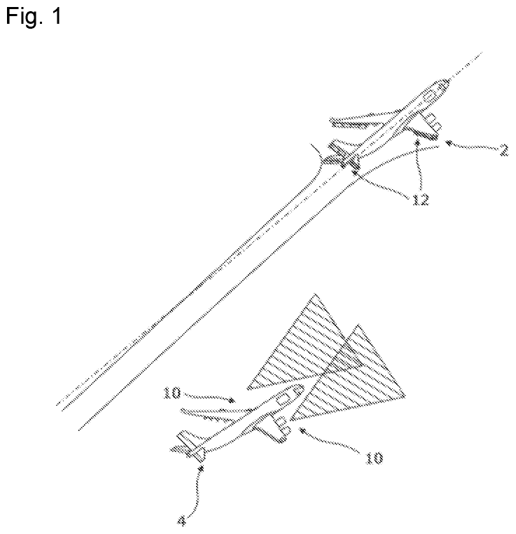

According to one possible application of the present invention described in the present application as an example, the system according to the present invention allowing the acquisition of the image of a lead airplane in a formation flight can be incorporated in a more general system and method for determining the positioning of a follower airplane with respect to a lead airplane flying in front of the follower airplane, which will not be described in more detail because it is not the subject of the present application as seen above. The lead airplane 2 and the follower airplane 4 are intended to form a formation flight as represented in FIG. 1.

Formation flight is understood to mean a formation composed of at least two airplanes in flight of which at least one is a lead airplane 2 and at least one is a follower airplane 4: the follower airplane 4 flies behind the lead airplane 2 and must hold its position with respect to the position of the lead airplane. It is therefore necessary to accurately and rapidly determine the position of the follower airplane with respect to that of the lead airplane to coordinate therewith.

To make it possible to determine its positioning with respect to the lead airplane 2, the follower airplane 4 must, in real time, determine the positioning data of the lead airplane 2 with respect to its own data. Positioning is understood to mean both the position in a cartesian reference frame of one airplane with respect to the other and also the orientation defined by three angles according to three rotations of one airplane with respect to the other.

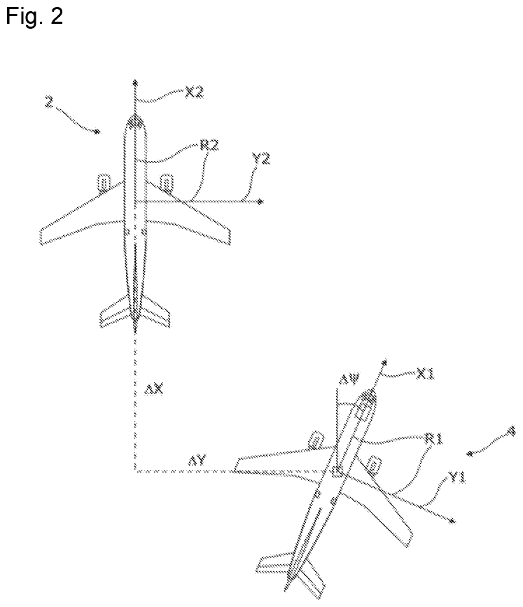

As illustrated in FIG. 2, each airplane 2, 4 is provided with a three-dimensional cartesian reference frame R2, R1 of which the origin is a particular, known, point of said airplane 2, 4. Said three dimensions are defined by three orthogonal axes denoted X, Y and Z. Furthermore, the origin of the reference frame of an airplane 2, 4 can be its mean center of gravity, or a point of the forward part of the fuselage of the airplane (i.e., the nose of the airplane).

Also, as illustrated in FIG. 2, the follower airplane 4 is provided with a three-dimensional cartesian reference frame R1, defined by the axes (X1, Y1, Z1), and the lead airplane 2 is provided with a three-dimensional cartesian reference frame R2, defined by the axes (X2, Y2, Z2). The position of a point in a reference frame, for example in the reference frame R1, is given by its coordinates according to the axes (X1, Y1, Z1). More particularly, in the present case, interest is focused on the position of the follower aircraft 4 with respect to the lead aircraft 2. Such a position is given by the coordinates of the origin of the reference frame R1 of the follower aircraft 4 in the reference frame R2 of the lead aircraft 2.

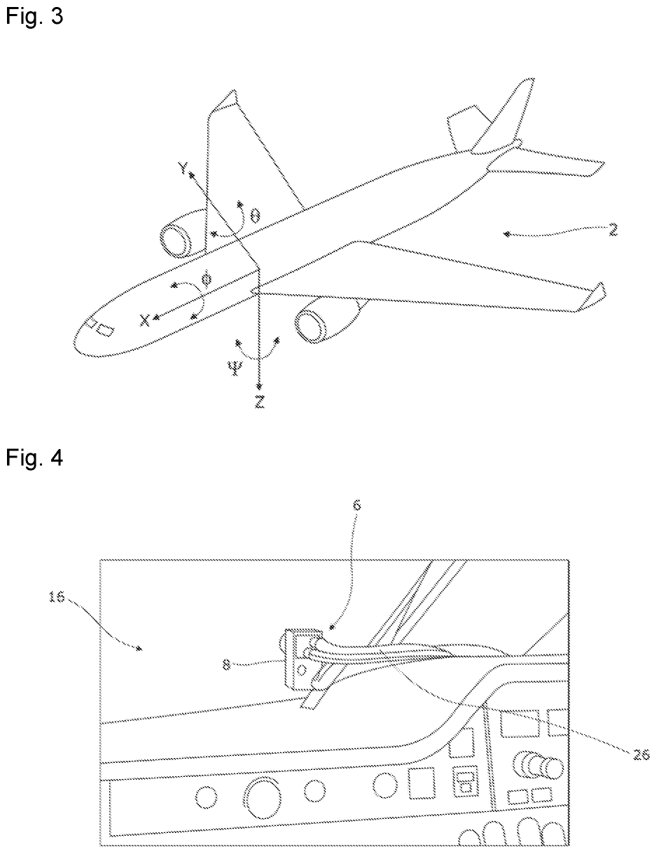

In this same embodiment and as represented in FIG. 3, the orientation of the follower aircraft 4 in the reference frame of the lead aircraft 2 is defined by three angles according to the three standard rotational movements of the aircraft: the roll angle, denoted Φ, the pitch angle, denoted Θ, and the yaw angle, denoted Ψ. The orientation of the follower aircraft 4 with respect to the lead aircraft 2 can also be defined by the angular deviations (denoted ΔΦ, ΔΘ, ΔΨ) respectively representing the angular deviation between the respectively roll, pitch, yaw angle of the follower aircraft 4 and the respectively roll, pitch, yaw angle of the lead aircraft 2 in the terrestrial reference frame.

Positioning of the follower aircraft 4 with respect to the lead aircraft 2 is understood to mean the position and the orientation of said follower aircraft 4 with respect to said lead aircraft 2. To determine this, it is necessary to acquire the image of the lead airplane in real time so making it possible to deduce the position and orientation with respect to the follower airplane.

As illustrated in FIGS. 4 to 6, the acquisition system 6 is mounted on the lead airplane 2 and the follower airplane 4 and is configured to acquire an image of the lead airplane 2 at a given time making it possible to determine, in real time, the abovementioned positioning data. The objective of such positioning determination is to provide positioning data to a user device determining flight instructions from the positioning data, notably for automatic (or autonomous) piloting of the follower aircraft 4 in the formation flight.

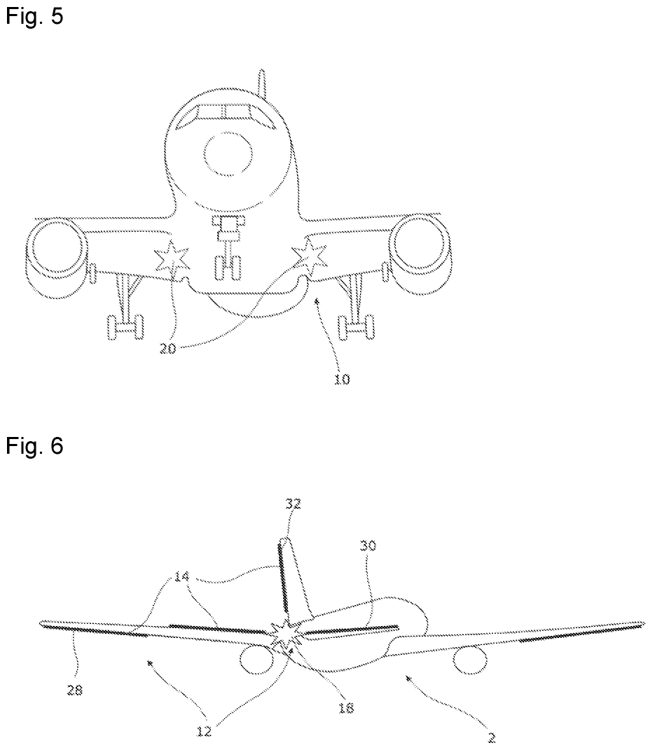

Such an acquisition is made difficult when the brightness drops, and even impossible at night. The acquisition system 6 according to the present invention comprises means that make it possible to determine the positioning and the orientation of the lead aircraft when the brightness conditions no longer permit that with the known systems. The acquisition system 6 according to the present invention comprises at least one camera 8 (FIG. 4) installed on or in the follower airplane 4, a lighting device 10 (FIG. 5) provided on the follower airplane 4 and oriented at least partially towards the lead airplane 2, a retroreflective device 12 (FIG. 6) of retroreflector type disposed on the lead airplane 2.

As illustrated in FIG. 4, the system 6 comprises at least one camera 8 that makes it possible to obtain real-time images of the lead airplane 2. The term camera is taken in a generic sense, namely an apparatus capable of taking images successively. The resolution of the camera should be great enough to ensure a good detection and obtain the measurement accuracy required by the positioning determination method. According to a particular embodiment, the minimum resolution is 200 pixels distributed over the wingspan of the lead airplane 2, which leads to a camera having a resolution of at least 4000*3000 pixels. The system 6 can comprise several video cameras 8 making it possible to obtain different images of the lead airplane 2, all processed to obtain the best possible extraction of the angular and positioning data of said airplane. In one embodiment, the camera 8 is a video camera fixed in the cockpit 16 of the follower airplane 4. The camera or cameras 8 are pointed forward: they must make it possible to frame all of the retroreflective device 12. In the example illustrated, they must allow all of the rear sector of the lead airplane 2 to be visualized. In the context of the present invention, the video camera 8 can be arranged at other points of the follower aircraft 4 where it is able to take the desired images. The video camera 8 is configured so as to be able to take images of the lead airplane 2 in video stream form. For example, the video camera 8 can be fixed on the nose cone of the fuselage of the follower airplane 4. Night-time measurement entails the use of a camera that is highly sensitive in low light conditions; the camera must be capable of detecting low brightness values. It must also have good contrast to make the detection of the images formed by the retroreflective device easy and accurate.

To visualize an airplane at night, it is possible to illuminate it from the follower airplane and to use surfaces of the lead airplane to naturally reflect the light, but that does not allow for a correct acquisition of the lead airplane by the follower airplane. In fact, the light power available is much too inadequate.

To overcome the difficulty of visualizing the lead airplane at night, the acquisition system according to the present invention uses a retroreflective device 12 of retroreflector type, also called corner cube retroreflectors, illustrated in FIG. 6. Such a device is characterized by the fact that all of the light beam received, in this particular case here, originating from the lighting device 10 of the follower airplane 4, is reflected regardless of its incidence in the direction of the incoming light flux: the reflected ray is parallel to the incident ray. Thus, all of the light flux originating from the follower airplane 4 is reflected to it and not disseminated into all the reflection space. Because of this, the light energy received is sufficient to be picked up by the camera or cameras 8 of the follower airplane 4.

The retroreflective device 12 is positioned on determined zones of the lead airplane 2. When lit, the retroreflective device allows the camera 8 to acquire an image of the zones marked by the device despite the reduced brightness. According to an embodiment illustrated in FIG. 6, the retroreflector 12 takes an oblong form, for example in the form of at least one strip 14. The term strip hereinafter in the description is understood in the sense of a retroreflective optical system strip. The retroreflector 12 need not be in oblong form and, in this case, several retroreflectors could be disposed juxtaposed so as to form an oblong arrangement which, from a distance, appears in the form of a line like the strip 14. The fact of using a strip 14 simplifies the fixing or the removal of the retroreflective device 12 on the lead airplane. The retroreflector 12 can be glued onto the surface of the lead airplane 2, for example by using a retroreflector in adhesive strip form. The retroreflector 12 can be fixed onto the lead airplane by any known type of means and preferably a removable means so as to be removed from the airplane without damaging it. The oblong form is chosen to allow an easier extraction of an image of the lead airplane making it possible to determine the position and the angle mentioned above. By choosing a positioning of the oblong retroreflectors 12, and, here, of the strips 14, in two orthogonal directions on the lead airplane, it is possible to extract the desired positioning data.

In fact, the acquisition of the image of the lead airplane depends on the form and the placement of the retroreflective device 12 on the lead airplane. In the form illustrated in FIG. 6, the retroreflective device 12 takes the form of a plurality of strips 14, placed on the outer surface of the lead airplane so as to make it possible to determine the abovementioned positioning data. For this, the strips 14 are disposed on lines on the axes Y and Z of the cartesian reference frame of the lead airplane 2. Thus, for example, the strips 14 are fixed on the axis Y on the wing and/or the horizontal tail unit and, on the axis Z, on the vertical tail unit and, more specifically for example, on control surfaces (comprising ailerons, flaps) of the wing and the horizontal and vertical tail unit. However, any other positioning is possible. According to one possible embodiment, at least some of the strips 14 are affixed on horizontal and vertical ridges of the airplane. In FIG. 6, a strip 14 is attached to the trailing edge 28 of each of the two wings of the lead airplane and, more specifically here, from the end of each of them to a point that makes it possible to cover at least 50% of its length, the length being the dimension taken in the direction Y. A strip 14 is positioned also on the trailing edge 30 of the two horizontal tail units over approximately all of their length. Finally, a strip 14 is placed over approximately all the length of the trailing edge 32 of the vertical tail unit. An additional retroreflector 12 takes the form of a surface that makes it possible to determine a point central to all of the retroreflectors installed rather than an oblong form intended to follow the form of the ridges of the airplane. In FIG. 6, a retroreflector 18 of circular form is placed at the end in the direction X of the tail unit of the lead airplane.

The follower airplane 4 is, for its part, provided with a lighting device 10. It can be of any type and in the embodiment illustrated, the lighting device uses one of those already in place on the airplane. In the embodiment illustrated in FIG. 5, the device 10 is all of the landing lights 20 of the airplane. The greater the light emission from the lighting device of the follower airplane, and the more focused it is on the retroreflective device 12, the greater the light intensity received by the sensor of the camera 8 and the easier the acquisition of the lines formed by the strips 14. Furthermore, the lines formed by the strips 14 are specific and easily detectable by conventional image processing methods such as outline detection using a Canny filter.

According to one embodiment, the camera 8 and/or the lighting device 10, when it is for example the landing lights 20, can be controlled manually from controls accessible in the cockpit 16. According to another embodiment, the acquisition system 6 comprises a centralized control unit to allow control from an interface of the camera 8 and/or of the lighting device 10. The control unit having an interface with the pilot makes it possible to control the sensor of the camera or cameras 8, the way in which images are acquired such as, for example, synchronization with an external source, the optical system of the camera such as the contrast of the image, the zoom level, etc., and quite simply also the starting and the stopping of said camera. In this way, the control unit makes it possible, from the interface, to start and stop the lighting device 10, to set the brightness and the orientation thereof, and/or any other available function.

As represented in FIG. 4, the acquisition system 6 is connected to a processing device, not represented, for processing the video stream originating from the camera. The processing device comprises a reception unit for the images transmitted in real time by the camera. According to the invention, “in real time” means that the latency time for the processing of an image is less than a limit time which allows the laws of automation, implemented by computer, which control the position of the aircraft, to perform correctly. In FIG. 4, the camera 8 is connected to said reception unit of the processing device by a connector 26. Said reception unit comprises a memory, for example a cache memory, for temporarily saving said images and making them available to an image processing unit.

In the processing of the image obtained by this unit, it is no longer necessary to extract the outline of the airplane. Use is made of a database stored in a memory of the system storing, not the complete three-dimensional models of the outline of the lead airplane, but the disposition of the zones marked by the strips 14 which, by being different according to the airplane concerned, characterizes it. According to one embodiment, the database contains the disposition of the marked zones for all the types of airplanes likely to be followed by the follower airplane. Extracting the outline of the airplane and using the model of the complete airplane remains a possibility but makes the positioning determination method more complicated. The actual device and processing method as seen above are not the subject of the present invention and are not therefore described in more detail.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for acquisition of an image of a lead aircraft by a follower aircraft, wherein the follower aircraft is flying behind the lead aircraft, wherein the system comprises:
at least one camera installed on or in the follower aircraft,
a lighting device provided on the follower aircraft and oriented at least partially towards the lead aircraft, and
a retroreflective device of retroreflector type disposed on the lead aircraft, the retroreflective device allowing the camera to acquire the image of zones marked by said retroreflective device.

2. The system according to claim 1, wherein the retroreflective device comprises at least one or more retroreflectors in an oblong form.

3. The system according to claim 2, wherein the retroreflective device is formed as strips disposed on an outer surface of the lead aircraft.

4. The system according to claim 3, wherein the strips are affixed onto ridges of a fuselage of the lead aircraft.

5. The system according to claim 4, wherein at least one of the strips is positioned on a part or all of a trailing edge of an air foil of the lead aircraft.

6. The system according to claim 3, wherein at least one of the strips is positioned on a part or all of a trailing edge of a horizontal tail unit of the lead aircraft.

7. The system according to claim 3, wherein at least one of the strips is positioned on a part or all of a trailing edge of a vertical tail unit of the lead aircraft.

8. The system according to claim 3, wherein at least one of the strips is positioned on a control surface of the lead aircraft.

9. The system according to claim 1, wherein the retroreflective device comprises a retroreflector at an end of a tail unit of the lead aircraft.

10. The system according to claim 1, wherein the lighting device comprises landing lights of the follower aircraft.

11. The system according to claim 1, wherein the following aircraft is flying behind the lead aircraft in formation flying.
